(19) United States
(12) Patent Application Publication
(10) Pub. No.: US 2022/0355463 A1
(43) Pub. Date: Nov. 10, 2022

(54) WORKSTATION AND STORAGE ORGANIZER WITH INVENTORY MANAGEMENT

(71) Applicant: Christopher Scott Sensing, II, Caledonia, MI (US)

(72) Inventor: Christopher Scott Sensing, II, Caledonia, MI (US)

(21) Appl. No.: 17/314,692

(22) Filed: May 7, 2021

(51) Int. Cl. B25H 3/02; G06Q 10/08

(52) U.S. Cl. CPC B25H 3/028; G06Q 10/087

(57) ABSTRACT

A storage organizer includes a storage cabinet having a plurality of storage bins for storing a plurality of items. Each storage bin has a location identifier for identifying a location of the storage bin. The storage organizer also includes an inventory management system for managing the inventory of the items stored inside the storage bins. The inventory management system includes a database having a location of each of the storage bin and a number of items stored inside each storage bin, and a user interface to enable a user to access the database for identifying a location of the storage bin having a desired item and a number of items stored in each storage bin.

### BACKGROUND OF THE INVENTION

### 1. Field of the Invention

The present invention relates to a storage organizer More particularly, the present invention pertains to a storage organizer having an inventory management system that facilitates a management of inventory stored within a storage cabinet of the storage organizer.

### 2. Description of the Prior Art

Cabinets are widely used to store parts, tools, etc., that are used for repairing an item. However, inventory of the items stored inside the storage cabinets is difficult to manage. This is especially true when the storage cabinet is a portable cabinet that is used by a field technician to repair the items.

### SUMMARY OF THE INVENTION

According to an aspect of the disclosure a storage organizer is disclosed. The storage organizer for maintaining an inventory of a variety of items is provided in which the storage organizer comprises a storage cabinet having a plurality of drawers, each drawer having at least one storage bin for storing a plurality of the items. The storage cabinet further has an identification system which includes a unique identifier associated with each storage bin for identifying a location of each respective storage bin. The storage cabinet additional includes an inventory management system for managing and monitoring the inventory of the items stored inside each of the storage bins, and the inventory management system includes a database having a location of each storage bin according to the identification system and a number of items stored inside each storage bin. The inventory management system further has a user interface to enable a user to access the database to identify the location of the storage bin having a desired item, view the number of items stored in each storage bin according to the database, and adjust the number of items stored in each storage bin as items are placed into or removed from each storage bin. The storage cabinet additionally includes a power system for providing electricity to the storage organizer, and the power system includes at least one battery.

Optionally, the storage cabinet includes a battery tester for testing external batteries.

Optionally, the storage cabinet includes a soldering unit that is electrically connected to and powered by the power system.

Optionally, the storage cabinet includes an RCA jack configured to test the functionality of audio/video component.

Optionally, the user interface of the storage cabinet includes a keypad and a display.

Optionally, the storage organizer includes a publication interface configured to store documents, and the publication interface is configured to be updated remotely.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 illustrates a perspective view of a storage organizer having a storage cabinet and an inventory management system, in accordance with an embodiment of the disclosure;

FIG. 2 illustrates a perspective view of the storage organizer depicting a plurality of storage bins of a storage cabinet, in accordance with an embodiment of the disclosure; and

FIG. 3 illustrates rear perspective view of the storage cabinet depicting a power system arranged inside a storage space of the storage cabinet, in accordance with an embodiment of the disclosure;

### DETAILED DESCRIPTION

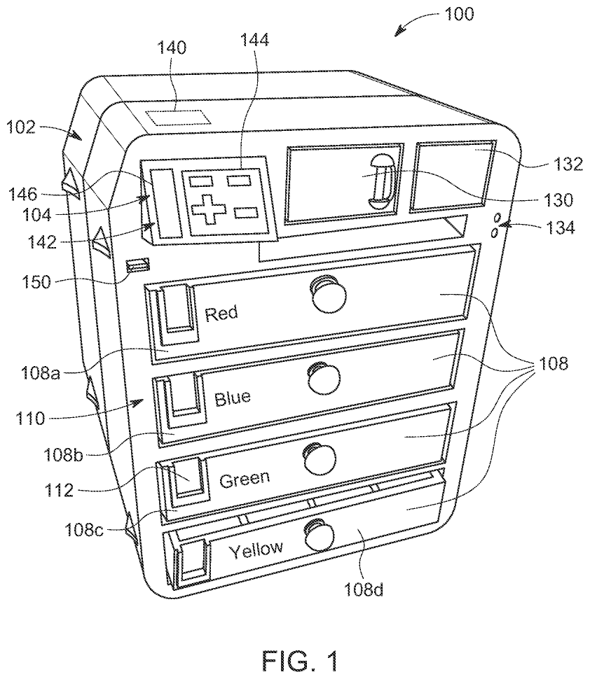

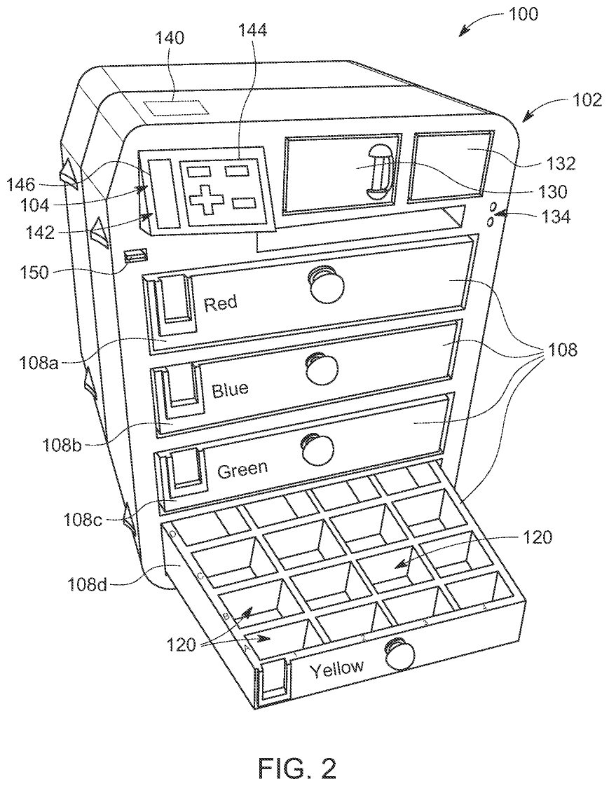

Referring to FIG. 1, a storage organizer 100 is disclosed which is suitable to facilitate an inspection and repair of any variety of items, such as, military helmets, wind turbines, racecars, or any other item that is typically inspected and repaired out in the field. Accordingly, the storage organizer 100 acts as a stand-alone repair station that can be used by technicians, plumbers, electricians, etc. to repair the item in the field. The storage organizer 100 includes a storage cabinet 102, an inventory management system 104, and a power system 106 for powering one or more systems or components of the storage organizer 100. As shown, the storage cabinet 102 is adapted to store various components or parts of the item to be repaired. The storage cabinet 102 includes a plurality of drawers 108, for example, four drawers 108a, 108b, 108c, 108d. To identify each of the drawers 108 of the storage cabinet 102, the storage cabinet 102 includes an identification system 110 having a separate unique identifier 112 for each of the drawers 108 and a plurality of storage bins 120 therein, which are discussed in greater detail below. The identifier 112 could be a color, letter, number, or any other suitable indicia to identify one of numerous locations. For example, the identifier 112 could be a color used to identify each of the drawers 108. In this example, a first drawer 108a, a second drawer 108b, a third drawer 108b, and a fourth drawer 108d could respectively be identified by a Red color label, a Blue color label, a Green color label, and a Yellow color label. Moreover, each of the drawers 108 includes a plurality of storage bins 120 (shown in FIG. 2) arranged in a grid structure or pattern and having a plurality of columns and a plurality of rows. Each storage bin 120 inside an associated drawer 108 is identified based on its column and row location in the grid structure. For example, each column can be associated with a unique number, and each row can be associated with a unique letter. For example, each storage bin 120 can then be identified by identifying the color of the drawer 108, and the row letter and column number within the grid. As such, a resulting location coordinate of a storage bin represented by Blue A4 corresponds to a storage bin 120 of the second drawer 108b located in the “A” row and the fourth column.

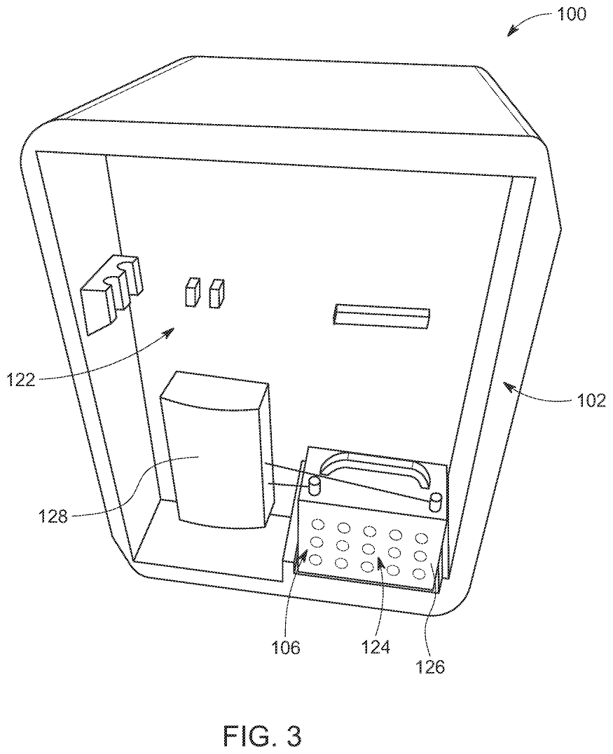

Further, as shown in FIG. 3, the storage cabinet 102 includes a power system 106 which is preferably located at a storage space 122 at a rear of the storage cabinet 102. The power system 106 has at least one power storage unit 124 having at least one battery 126 to provide power to various components associated with the storage organizer 100. Preferably the power system 106 also includes a power converter 128 located inside the storage space 122 and electrically coupled with the power storage unit 124 and various electrical components of the storage organizer 100 to provide and control a flow of power/electricity to the electrical components. Accordingly, the power system 106 allows the storage organizer 100 to be brought out to, and used in the field for extended duration without the need of an external power source.

Referring back to FIGS. 1 and 2, one of the aforementioned electrical components of the storage organizer 100 can include a battery tester 130 for testing batteries of the item being repaired and/or inspected. As an example, the battery tester 130 may be an AA/AAA/C/D/9-volt type battery tester for testing one or more parameters and working of the batteries. It should be understood that if the item being inspected includes batteries, then it may be important to ensure that any batteries going out into the field are functioning adequately and have sufficient battery life left. The battery tester 130 is mounted on the storage cabinet 102 and may include a chamber for storing the battery tester 130.

Optionally the storage organizer 100 may include a soldering unit 132 that may be located inside another storage chamber of the storage cabinet 102. The soldering unit 132 may be electrically connected to, and powered by, the power system 100. The soldering unit 132 includes a soldering iron (not shown), flux, or any other suitable components. It is to be appreciated that the soldering unit 132 allows electrical components to be replaced when the item is repaired.

Further, the storage cabinet 102 may optionally include an RCA jack 134 to test the functionality of audio/video equipment or components, such as microphones and earpieces/speakers.

The inventory management system 104 includes a database 140 for storing a location of each of the items arranged inside the storage cabinet 102, and also an inventory of the items available inside each storage bin 120. The inventory management system 104 also includes a user interface 142 having an input, such as a keypad 144, and a display 146 to allow a user to access information about the inventory of each item stored inside the storage cabinet 102 and to update the inventory of each item as the items are added or withdrawn from the storage bins 120. The user interface 142 can also include a touch-sensitive screen which can function as both the keypad 144 and the display 146. For example, the user may identify the location of a storage bin 120 holding a desired item by entering an item code or name via the user interface 142. The user may also access a number of items stored in any storage bin 120 by entering a location coordinate of the storage bin 120 through the keypad 144. Further, the keypad 144 facilitates in updating the inventory information of each storage bin 120 as the items are added or withdrawn from the storage bins 120. The information may be updated by entering the location coordinates of the associated storage bin 120 and then using addition or subtraction keys or any other suitable keys of the keypad 144. The keypad 144 may include alphanumeric keys to enable the user to input desired search query or location coordinates.

In an embodiment, the database 140 may be stored in a hard drive located inside the storage cabinet 102. Alternatively, the database 140 may be located at a remote location and may be accessed by a suitable remote communication means, such as Bluetooth®, Wi-Fi, a mobile telecommunication network, or even via a satellite communication. In some embodiments, the locally stored database 140 may be connected to a remote server with the help of an auxiliary device, such as a computer, to facilitate access of the information stored inside the database 140 from a remote location and a use of the inventory management system 104 from the remote location. In such a case, the storage organizer 102 may include a USB port 150 or a serial port to enable the connection of the inventory management system 104 with the auxiliary device. In addition, the computing system may facilitate the download, upload, and updating of the information regarding the plurality of items present inside the storage bins 120. Additionally, the inventory management system 104 monitors the level of inventory of each item/part stored in the storage bins, and can generate an order when the inventory of any item/part decreases below a threshold value. It may be appreciated that the threshold value for one part/item may be different from a threshold value for another part/item.

Furthermore, the storage organizer 100 may include an instruction manual or publication interface to store documents or manuals, for example, inspection manuals or repair manuals. The publication interface may also enable a retrieval and access of the manuals by running a search query or entering a name of the manual. Also, the publication interface facilitates an updating of the manuals from a remote server or a world-wide internet when a remote server or the world-wide internet is connected to the storage organizer. In some embodiments, the publication interface generates an update request to update a manual after a lapse of a certain time duration from a previous update of the manual. Alternatively, the user may manually check for any updated manual, and then correspondingly update the manual on the publication interface. In use, it is envisioned that an update to a document, such as a repair manual, may be produced by a central controlling entity. That updated repair manual is then pushed or distributed to each storage organizer 100 out in the field to ensure that all future inspections and/or repairs incorporate the update. For example, if a particular component is found to have a design flaw, then an update can be made to the repair manual, the repair manual is distributed to the field, and future inspections and repairs will be made to swap out the compromised component.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended specification.

I claim:

1. A storage organizer for maintaining an inventory of a variety of items, the storage organizer comprising:
a storage cabinet having a plurality of drawers, each drawer having at least one storage bin for storing a plurality of the items, the storage cabinet further having an identification system which includes a unique identifier associated with each storage bin for identifying a location of each respective storage bin;
an inventory management system for managing and monitoring the inventory of the items stored inside each of the storage bins, the inventory management system including a database having a location of each storage bin according to the identification system and a number of items stored inside each storage bin, the inventory management system further having a user interface to enable a user to access the database to identify the location of the storage bin having a desired item, view the number of items stored in each storage bin according to the database, and adjust the number of items stored in each storage bin as items are placed into or removed from each storage bin;
a power system for providing electricity to the storage organizer, the power system including at least one battery; and
a battery tester for testing external batteries.

2. The storage organizer of claim 1 including a soldering unit that is electrically connected to and powered by the power system.

3. The storage organizer of claim 2 including an RCA jack configured to test the functionality of audio/video component.

4. The storage organizer of claim 3 wherein the user interface includes a keypad and a display.

5. The storage organizer of claim 1 including an RCA jack configured to test the functionality of audio/video component.

6. The storage organizer of claim 1 including a publication interface configured to store documents, the publication interface further being configured to be updated remotely.

7. The storage organizer of claim 1 wherein the user interface includes a keypad and a display.

8. A storage organizer for maintaining an inventory of a variety of items, the storage organizer comprising:
a storage cabinet having a plurality of drawers, each drawer having at least one storage bin for storing a plurality of the items, the storage cabinet further having an identification system which includes a unique identifier associated with each storage bin for identifying a location of each respective storage bin;
an inventory management system for managing and monitoring the inventory of the items stored inside each of the storage bins, the inventory management system including a database having a location of each storage bin according to the identification system and a number of items stored inside each storage bin, the inventory management system further having a user interface to enable a user to access the database to identify the location of the storage bin having a desired item, view the number of items stored in each storage bin according to the database, and adjust the number of items stored in each storage bin as items are placed into or removed from each storage bin;
a power system for providing electricity to the storage organizer, the power system including at least one battery; and
a soldering unit that is electrically connected to and powered by the power system.

9. The storage organizer of claim 8 including an RCA jack configured to test the functionality of audio/video component.

10. The storage organizer of claim 9 wherein the user interface includes a keypad and a display.

11. The storage organizer of claim 8 including a publication interface configured to store documents, the publication interface further being configured to be updated remotely.

12. The storage organizer of claim 8 wherein the user interface includes a keypad and a display.

13. A storage organizer for maintaining an inventory of a variety of items, the storage organizer comprising:
a storage cabinet having a plurality of drawers, each drawer having at least one storage bin for storing a plurality of the items, the storage cabinet further having an identification system which includes a unique identifier associated with each storage bin for identifying a location of each respective storage bin;
an inventory management system for managing and monitoring the inventory of the items stored inside each of the storage bins, the inventory management system including a database having a location of each storage bin according to the identification system and a number of items stored inside each storage bin, the inventory management system further having a user interface to enable a user to access the database to identify the location of the storage bin having a desired item, view the number of items stored in each storage bin according to the database, and adjust the number of items stored in each storage bin as items are placed into or removed from each storage bin;
a power system for providing electricity to the storage organizer, the power system including at least one battery; and
a publication interface configured to store documents, the publication interface further being configured to be updated remotely.

14. The storage organizer of claim 13 including an RCA jack configured to test the functionality of audio/video component.

15. The storage organizer of claim 14 wherein the user interface includes a keypad and a display.

16. The storage organizer of claim 13 wherein the user interface includes a keypad and a display.
